(19) United States
(12) Patent Application Publication
(10) Pub. No.: US 2004/0140998 A1
(43) Pub. Date: Jul. 22, 2004

(54) CONTROLLER AND REMOVABLE USER INTERFACE (RUI) FOR CONTROLLING MEDIA EVENT

(76) Inventors: Craig S. Gravina, Saratoga Springs, NY (US); Arthur A. Gravina, Naples, FL (US)

Correspondence Address: MORRIS, MANNING & MARTIN LLP, 6000 FAIRVIEW ROAD, SUITE 1125, CHARLOTTE, NC, 28210, US

(21) Appl. No.: 10/605,870

(22) Filed: Nov. 2, 2003

Related U.S. Application Data
(60) Provisional application No. 60/423,161, filed on Nov. 1, 2002.

(51) Int. Cl. G09G 5/00

(52) U.S. Cl. 345/716

(57) ABSTRACT

An apparatus for controlling a media event includes a controller capable of communicating with a media device and an overlay removably attached to the controller. The controller includes a processor for performing machine executable instructions for communicating one or more commands to the media device. The overlay includes a plurality of user inputs and a machine readable medium having machine executable instructions comprising commands for controlling a media event. Each user input is disposed for direct contact by a user in actuating the user input. Upon actuation of a user input, the processor performs a device independent instruction of the overlay resulting in performance of a device specific instruction of the controller, thereby communicating a device specific command to the media device.

### CROSS REFERENCE TO RELATED APPLICATIONS

The present application claims priority under 35 U.S.C. section 119 to Craig Gravina U.S. provisional patent application serial no. 60/______, titled “SmartToys Multimedia Learning System,” filed Nov. 1, 2002 with the U.S. Patent & Trademark Office (attorney docket number GRAV-0001), which provisional patent application is hereby incorporated by reference herein.

### COPYRIGHT STATEMENT

All of the material in this patent document, including source code, is subject to copyright protection under the copyright laws of the United States and of other countries. The copyright owner has no objection to the facsimile reproduction by anyone of the patent document or the patent disclosure, as it appears in the Patent and Trademark Office patent file or records, but otherwise reserves all copyright rights whatsoever.

### COMPUTER PROGRAM LISTING APPENDIX

Submitted herewith and incorporated herein by reference are source code files comprising a computer program listing appendix that represents a preferred embodiment of the present invention. The computer program listing appendix includes source code for a script engine and source code for a compiler for compiling of script. The source code for the script engine is written in ANSI C, and the source code of the compiler is written in Visual Basic. The target hardware for this implementation is a PIC microprocessor, model number 18F8720. Forty-three computer listing files are submitted herewith as itemized on the Transmittal, which is incorporated herein by reference. All files represent source code of the script engine except for those files as identified in the “readme.txt” file and the “PushPlayScriptingAPI.txt” file.

### BACKGROUND OF INVENTION

1. Field of the Invention

As a preliminary matter, the field of the present invention generally relates to controlling media events using a controller and removable user interface (RUI) and, with regard to certain preferred embodiments, to controlling presentation of media content using one or more controllers and one or more RUIs. In this regard, a media event includes the displaying of video content and/or audio content, referred to herein as media presentation. Generally, however, a media event also may include the capturing, recording, transferring, and/or moving of video and/or audio content, depending upon the context.

2. Background of Certain Preferred Embodiments

As of 2002, DVD players continue to grow and all indications suggest that sales will remain strong for years to come. Shipments of DVD players grew by 61% in 2002, reaching a total install base of over 40M US households. With a proliferation rate that makes the device the fastest adopted format in electronics history, most estimates predict an install base of at least 60M households by 2006. The DVD format, introduced in 1997, will likely be ubiquitous within 12 years, less than half the time it took for VCRs to reach that status.

Moreover, due to a growing desire to educate (and occupy) children through television and videos, families with children under four years old are now the highest video purchasing customers with an astonishing average of preschool home video market. Indeed, parents have been recently become particularly interested in educational videos for their youngest children, the infant/toddler segment. However, despite the undeniable appeal to children of videos, many parents in focus groups confessed unease at using videos with their youngest children due to the “passive” nature of the viewing. Unlike educational toys, in which the experience of the infants and toddlers is “hands on,” children may tend to lose interest in educational videos, especially when an educational video is highly repetitive, repeating one basic lesson over and over again with various puppets, cartoons, songs and so on (which most educational videos tend to do).

Accordingly, a need exists for an interactive educational DVD video system that is interactive and, thereby, tends to maintain the attention and interest of children viewing the video. In this respect, and in accordance with an aspect of the present invention, a child viewing the video is able to interact, for example, by controlling educational segments of the video that are displayed; and/or by responding to questions presented in the video with appropriate responses indicating whether the response is correct.

While certainly broader in its utility, the present invention addresses this need with respect to certain preferred embodiments thereof, as described in detail below.

### SUMMARY OF INVENTION

Briefly described, the present invention relates to controlling a media event.

In a first aspect of the present invention, a host system includes a machine readable medium containing media content and an apparatus for controlling presentation of the media content. The apparatus includes a removable user interface (RUI) and a controller removably coupled together. In this aspect of the present invention, the RUI includes user inputs and machine executable instructions (i.e., software) that are specific to the media content. The controller includes a processor, a program executed by said processor that interprets the machine executable instructions of the RUI, and a library of software instructions accessible to the program for communicating to the host system, in a protocol of the host system, commands relating to presentation of the media content. The program, in response to actuation of a user input, performs the steps of reading and/or interpreting the machine executable instructions of the RUI, accessing the software instructions in the library based on the machine executable instructions read from the RUI, and communicating commands to the host system based on the accessed software instruction of the library.

In a different, second aspect of the present invention, a media device includes a controller in at least intermittent communication with a media device and an overlay that is removably coupled to the controller. The controller includes a processor for executing software instructions. The overlay includes a plurality of user inputs and a machine readable medium having machine executable instructions comprising commands for controlling media events, whereby an appropriate communication to the media device is determined by the processor of the controller upon actuation of a user input. In accordance with this particular aspect of the present invention, the user inputs are exposed for direct contact by a user in actuation thereof, with the actuation of a user input causing the communication from the controller to the media device; the machine executable instructions of the overlay may or may not be specific to any media content; and the commands may or may not be media device independent.

These and other aspects, as well as features of the present invention, will be more readily understood upon consideration of the attached drawings and of the following detailed description of preferred embodiments of the present invention.

### BRIEF DESCRIPTION OF DRAWINGS

Further features and benefits of the present invention will be apparent from a detailed description of preferred embodiments thereof taken in conjunction with the following drawings, wherein similar elements are referred to with similar reference numbers, and wherein,

FIG. 1 is an overview of a preferred embodiment of a system of the present invention having a media device for presenting media presentation.

FIG. 2 is a perspective view of a preferred embodiment of an apparatus of the present invention for controlling media presentation, which figure illustrates the combination of a removable user interface (RUI) with a controller in forming the apparatus.

FIG. 3 is a perspective view of three media packages in accordance with a preferred embodiment of the present invention, each media package including a RUI and a DVD pair, wherein the media content of the DVD of a respective pair corresponds to the RUI of the pair.

FIG. 4 is an other media package in accordance with a preferred embodiment of the present invention.

FIG. 5 is an other media package in accordance with a preferred embodiment of the present invention, wherein the media content comprises home videos taken with a digital recorded that is saved on the DVD of the media package.

FIG. 6 is a perspective view of another preferred embodiment of a RUI and controller of the present invention for controlling media presentation.

FIG. 7 is a perspective view of another preferred embodiment of a RUI and controller of the present invention for controlling media presentation.

FIG. 8 is a plan view of a preferred embodiment of a RUI of the present invention for combining with the controller of FIG. 9.

FIG. 9 is a plan view of a preferred embodiment of a controller of the present invention for combining with the RUI of FIG. 8, which controller includes a switch matrix.

FIG. 10 is a plan view of a preferred embodiment of a RUI of the present invention for combining with the controller of FIG. 11, which RUI includes a switch matrix.

FIG. 11 is a plan view of a preferred embodiment of a controller of the present invention for combining with the RUI of FIG. 10.

FIG. 12 is a view of a computer screen representing an exemplary script in accordance with a preferred embodiment of the present invention.

FIG. 13 is a view of a computer screen representing an exemplary script in accordance with a preferred embodiment of the present invention.

FIG. 14 is a view of a computer screen representing an exemplary script in accordance with a preferred embodiment of the present invention.

FIG. 15 is a view of a computer screen representing an exemplary script in accordance with a preferred embodiment of the present invention.

FIG. 16 is a view of a computer screen representing machine-executable instructions of a library of a controller in accordance with a preferred embodiment of the present invention, the instructions being specific to a Sony DVD player.

FIG. 17 is a view of a computer screen representing an exemplary script in accordance with a preferred embodiment of the present invention.

FIG. 18 is an illustration of operation of the Interpreter in a preferred embodiment of the present invention, and in accordance with the exemplary script of FIG. 17.

### DETAILED DESCRIPTION

As a preliminary matter, it will readily be understood by those persons skilled in the art that the present invention is susceptible of broad utility and application in view of the following detailed description of preferred embodiments of the present invention. Many devices, methods, and adaptations of the embodiments other than those herein described, as well as many variations, modifications, and equivalent arrangements, will be apparent from or reasonably suggested by the following detailed, without departing from the substance or scope of the present invention. Accordingly, while the present invention is described herein in detail in relation to preferred embodiments, it is to be understood that this disclosure is illustrative and exemplary and is made merely for purposes of providing a full and enabling disclosure of the present invention. The detailed description set forth herein is not intended, nor is to be construed, to limit the general breadth of the present invention or otherwise to exclude any such other embodiments, adaptations, variations, modifications and equivalent arrangements, the present invention being limited only by the claims and equivalents thereof.

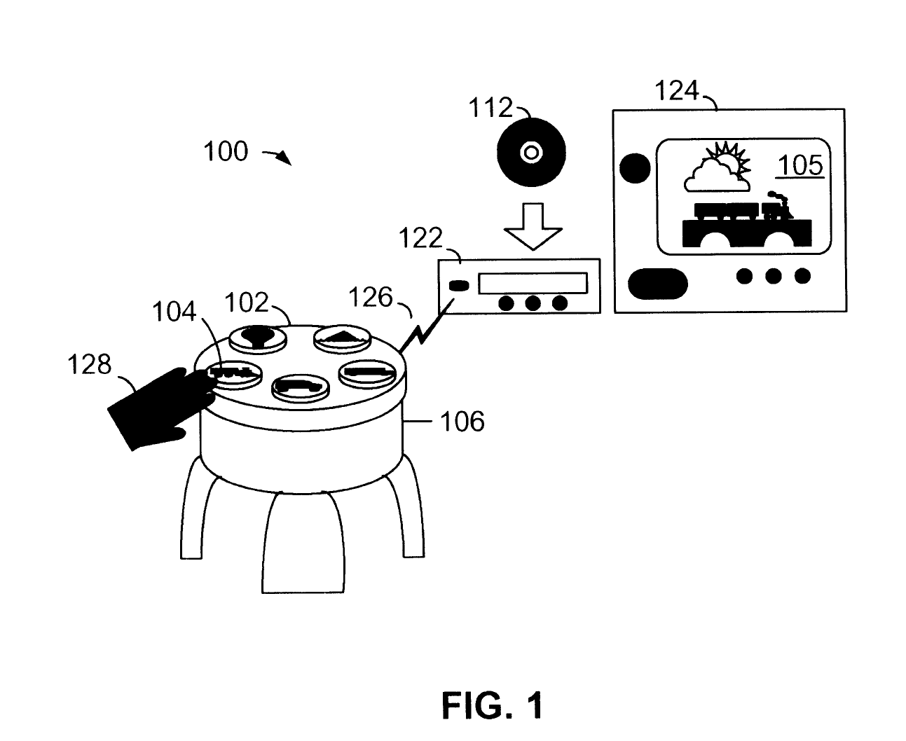

With reference to FIG. 1, a preferred embodiment 100 of a system of the present invention is illustrated. This preferred embodiment 100 includes a multimedia system having a DVD player 122 for reading DVD 112 and associated video monitor or television 124 for displaying on screen 105 media content read from DVD 112. The DVD 112 in this preferred embodiment is an educational video for a child that pertains to different methods of transportations, including transportation by hot air balloons, sail boats, trains, trucks, and buses. The DVD player 122 is a conventional DVD player having an infrared receiver for receiving commands controlling presentation (e.g., display on screen 105) of the media content of the DVD 112. Conventionally, these commands are issued from a remote control device that accompanied the DVD player when it was purchased, or from a “universal” remote control device that was purchased separately and that includes the ability to send commands for various different DVD players including DVD player 122.

The preferred embodiment 100 of FIG. 1 also includes an apparatus for controlling the presentation of the media content, but the apparatus is not one of these conventional remote control devices. Instead, the apparatus for controlling the presentation of the media content is a child's activity table for control of the media content by the child. In this regard, the activity table comprises a platform or table like structure comprising a base structure 106 having any suitable number of legs or supports 108 (which may or may not be detachable), and an upper component comprising an overlay 102. The overlay 102 includes a plurality of user inputs comprising large buttons 104, and the activity table 106 includes the ability to issue commands wirelessly via signals 126 to the DVD player 122 in response to the pushing of the buttons by hand.

In particular, the pushing of a button (i.e., actuation of a user input) results in the DVD player 122 displaying a particular educational segment on screen 105. Moreover, in this preferred embodiment 100, the button includes graphical indicia pertaining to the media content that is displayed as a result of pushing the button. Thus, the pushing by hand 128 of the button including indicia of a train results in an educational video segment being displayed pertaining to trains. In other words, pressing a button lets a child trigger presentation of media content associated with the subject matter that is indicated by the button. This type of interaction between a user and media presentation is most suitable for children within the age groups of one to three, teaching a child basic motor skills and empowering the child, and is preferably used to instruct a child about basic sets of abstract concepts regarding, for example, colors, shapes, letters, numbers, animals, and instruments.

It should also be noted that greater interactive content media also can be utilized. In this regard, the media content presentation may include a “question and answer”” format, wherein the media content displayed directly poses a question that can be answered by pushing a particular button. As an example, a segment of a video may state, “Click on the animal that eats bananas,” and wherein the child then clicks on the button depicting a monkey and triggers the positive response “You're right! A monkey eats bananas!” or, alternatively, clicks on a button depicting another animal and triggers the response “Sorry, Please try again!” Alternatively, the media content presentation may include a “choose your own adventure” format, wherein the media content narrative pauses at key points in a storyline in order for the child determine the future direction of the story. As an example, a segment of the video may state, “Should you go take the road going North or the road going South?” and wherein, if the child then clicks on the button indicating “North” the story resumes with that choice as its basis and if the child then clicks on the button indicating “South” the story resumes with that alternative choice as its basis.

As will be appreciated, overlay 102 is not generic to DVD 112 because the overlay 102 provides illustratively labeled button 104 that are correlated to different portions of the media content of DVD 112.

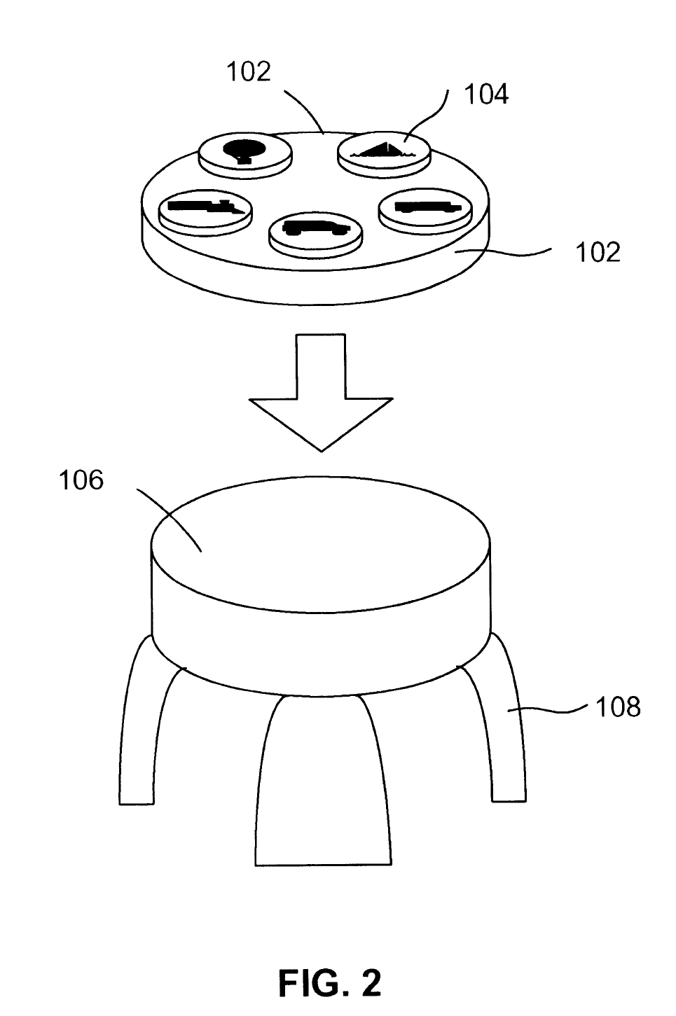

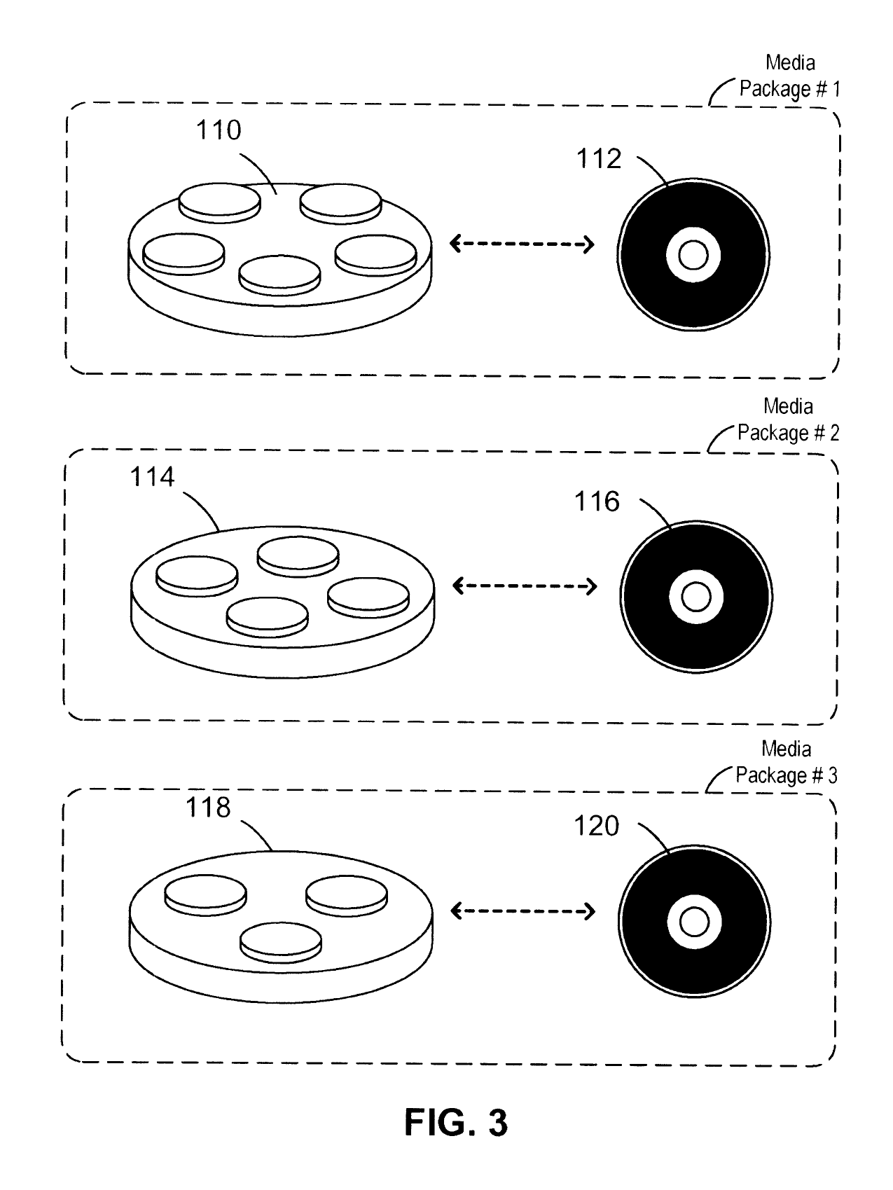

In accordance with the present invention, the overlay 102 of FIG. 1 is removably attachable to the base structure 106 as illustrated in FIG. 2. Accordingly, the base structure 106 may accept any one of various overlays corresponding to different DVDs that may be used in the multimedia system. Thus, for example, with reference to FIG. 3 the three different media packages may be used with base structure 106. Indeed, each media package comprises a DVD and an overlay corresponding to that DVD's media content. DVDs 112, 116, 120 thus respectively correspond to overlays 110, 114, 118, and each of the overlays includes a different number of buttons with different indicia (not shown) thereon.

With regard to the various aspects of the present invention, the multimedia system of FIG. 1 is an example of a host system, the base structure 106 is an example of a controller, and the overlay is an example of a removable user interface (RUI). Additionally, the buttons of the overlay 102 are an exemplary embodiment of user inputs.

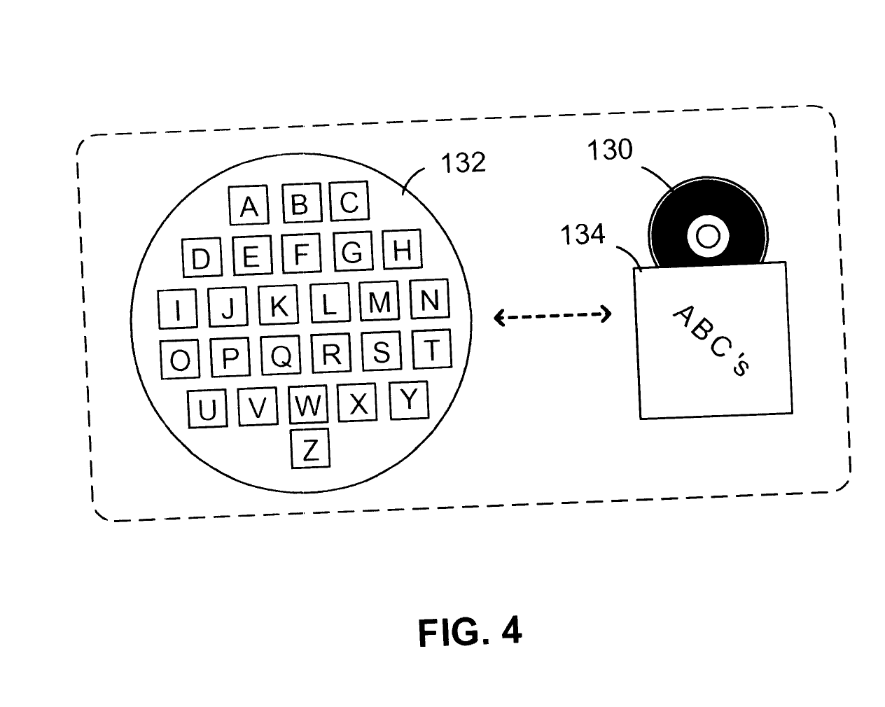

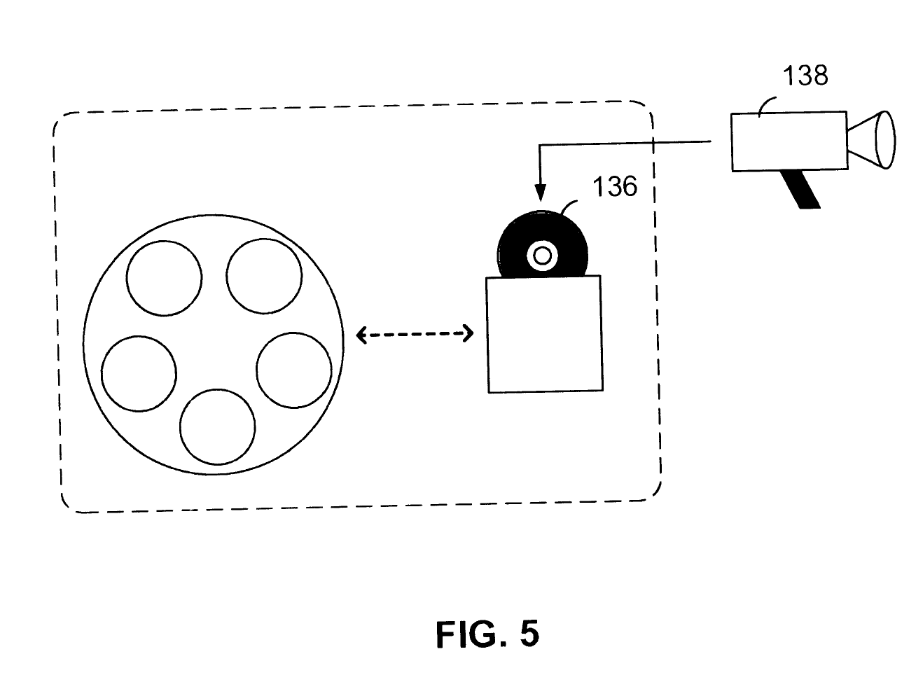

A preferred media package is illustrated in FIG. 4, and includes a CD 130 having data for songs drawn to letters of the alphabet. The corresponding overlay 132 includes an array of buttons having these letters of the alphabetic illustrated thereon for effecting user selection of songs on the CD 130. A sleeve 134 is useful to store, protect, and identify the CD 130 that is correlated with the overlay 132. Another preferred media package is illustrated in FIG. 5, wherein a DVD 136 has been used with a video recorder 138 to create videos. In accordance with the present invention, user actuation of a button of the overlay initiates playback of a particular video corresponding to indicia (not shown) of that button.

Other preferred embodiments of media packages (not shown) include a media package for use or study of geographic content regarding the United States or geometric shapes. In the former example, the overlay is arranged as a map with the buttons shaped and arranged as states. Upon pushing of a state shaped button then would result in presentation of educational information on that state, which information is stored on a DVD corresponding to the overlay. In the latter example, the overlay includes buttons of various geometric shapes, such as a circle, triangle, rectangle, and square. Upon pushing of a geometrically shaped button then would result in presentation of educational information on that particular geometric shape of the button, which information is stored on a DVD corresponding to the overlay.

In should be noted that, in the preferred embodiments of FIGS. 4 and 5, the overlays are examples of RUIs, and the CD and DVD are examples of machine readable media having media content. Additionally, the correspondence between a RUI and machine readable medium having the media content is represented in FIGS. 1 and 5 by the dashed arrows pointing therebetween.

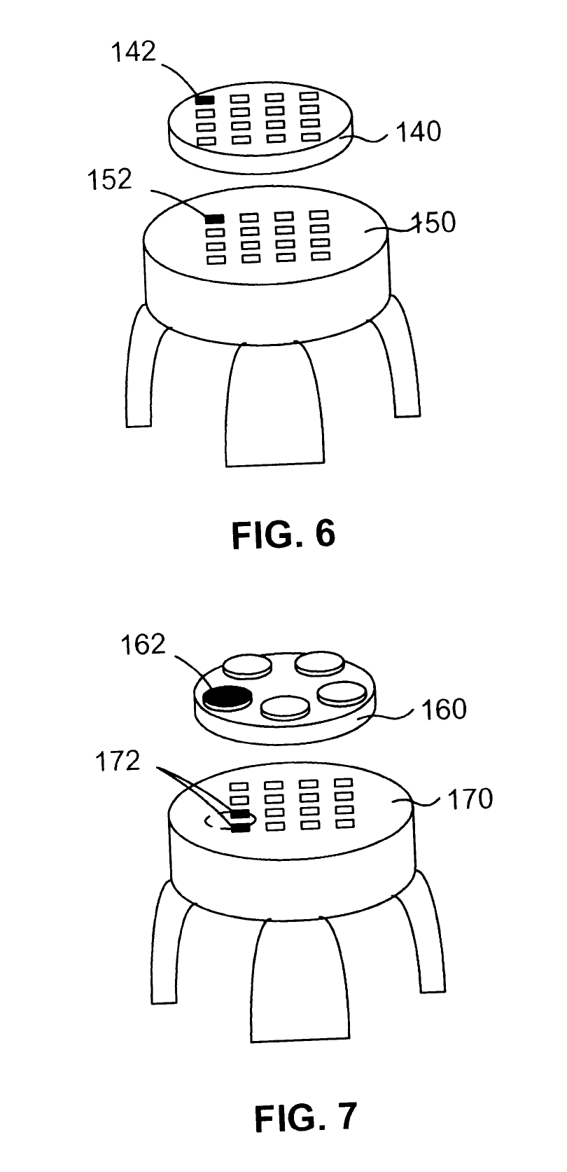

With respect to the attachment of an overlay to a controller, FIG. 6 illustrates an overlay 140 that is attachable to base structure 150, wherein an array of user inputs (represented by rectangles) corresponds identically to an electrical switch matrix of the base structure 150. Thus, inputs 142 corresponds with switch 152, whereby user actuation of input 142 results in a signal being generated by switch 152. A similar arrangement is illustrated in FIG. 7; however, in FIG. 7 there are fewer user inputs than switches. Thus, for example, actuation of input 162 results in a signal being generated by switches 172. In these illustrated arrangements, each of the particular inputs 142,162 comprises a mechanical component that, when the respective overlay 140,160 is coupled to the base structure 150,170, is positioned directly above the respective switches 151,172.

It should be understood that any desired or suitable n to m correlation of any number (n) inputs to any number (m) of controller switches is within the scope of the present invention. Furthermore, though the figures illustrate for convenience spatial alignments of user inputs to correlated controller switches, it should be understood that other alignments or associations facilitated by cantilevers, pads, moving parts, or electrical contacts correlating any one, any number, or any area of inputs to any one, any number, or any area of controller switches are within the scope of the present system.

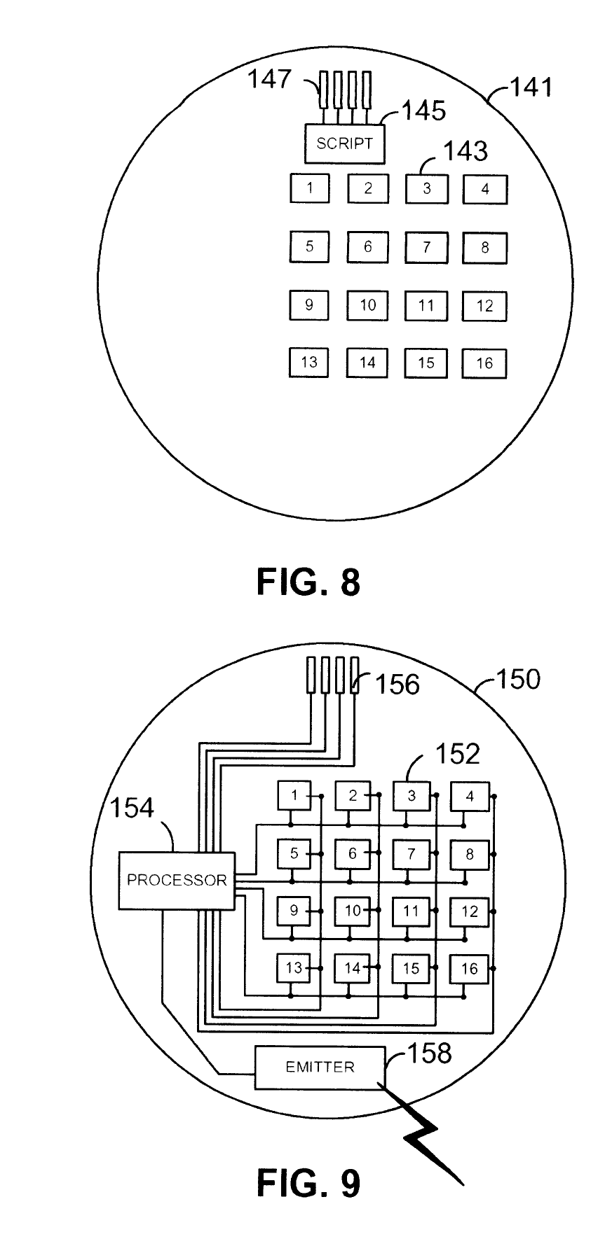

With reference now to FIGS. 8 and 9, an exemplary plan diagram of a RUI and controller is shown. The RUI 141 comprises a thin membrane or sheet having inputs 143 that comprise designated rectangular areas for guiding the application of pressure by a user's finger. Furthermore, the inputs 143 comprise a 4×4 array. When the RUI is attached to the controller, each of the inputs 143 overlie and align with rectangular switches 152 of a switch matrix of the controller 150. Thus, when the RUI 141 is attached to the controller 150, a user applying pressure to an input 143 causes a particular the switch 152 thereunder to provide an electronic signal.

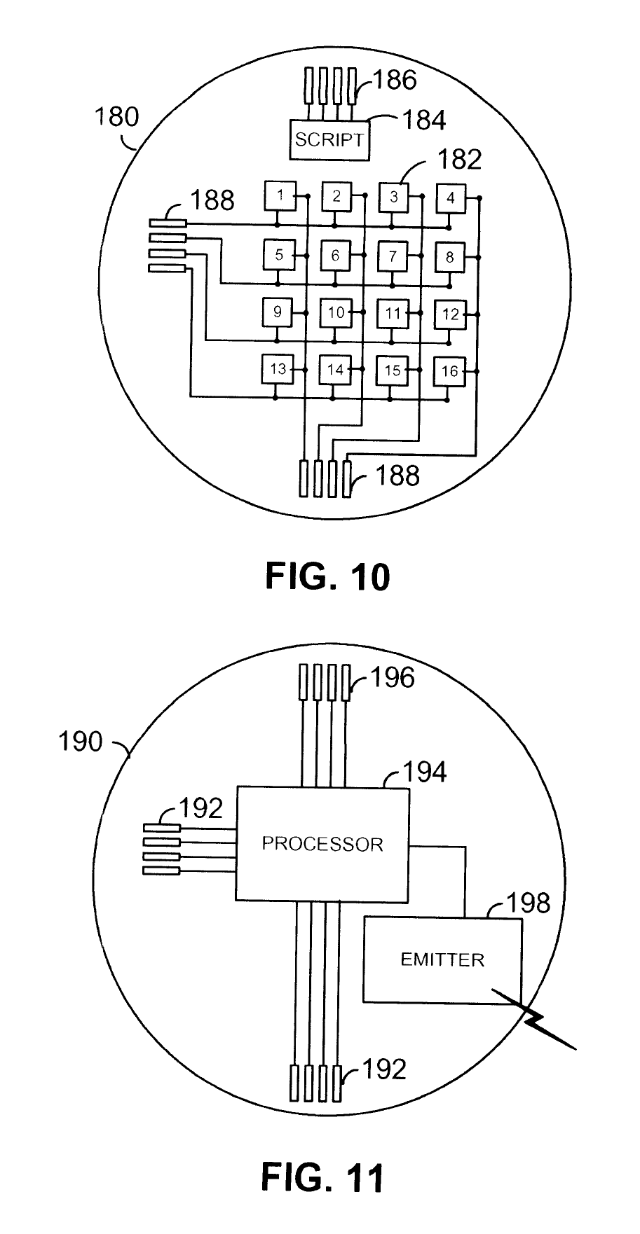

A similar, but alternative exemplary plan diagram of a RUI and controller is shown, respectively, in FIGS. 10 and 11. In this instance, a switch matrix is included in the RUI 180 rather than in the controller 190. Indeed, the switches 182 of the switch matrix of the RUI 180 comprise, themselves, the user inputs of the present invention. When the RUI 180 is attached to the controller 190, each of the inputs 143 overlie and align with rectangular switches 152 of a switch matrix of the controller 150. A user applying pressure to a particular switch 182 of the RUI 180 causes a an electronic signal to be provided.

Whether an electronic signal is provided by a switch in the controller 150 of FIG. 9, or by a switch in the RUI 180 of FIG. 10, a processor in the controller, which processor preferably comprises a microprocessor, receives the signal provided by the switch when the RUI is attached to the controller. In this regard, a signal provided by a switch 142 in controller 150 is communicated directly from the switch matrix to processor 154, and a signal provided by a switch 182 in the RUI 180 is communicated from the switch matrix of the RUI 180 to processor 194 in the controller 190 through electrical contacts 188 of the RUI 180 that abut electrical contacts 192 of the controller 190. A power source, such as a battery (not shown), preferably is included in the controller for generating electrical signals from switches.

Upon receiving an electronic signal, ultimately in response to actuation of a user input of a RUI, the processor (in accordance with a program that it runs) responds appropriately such as, for example, by causing an emitter, which is also included in the controller, to transmit an appropriate command to a media device. The emitter can be any wireless transmission device, for example, a radio frequency (RF) transmitter, an infrared (IR) emitter, an IRDA device, or a Bluetooth device. Alternatively or in conjunction with a wireless device, the emitter can comprise any conducting wire or fiber optic signal generator. The emitter sends signals to control external devices such as DVD players, CD players, computers, and televisions, just to name a few. The emitter can be coupled to one or more media devices through a parallel port connection, a serial port connection, or a USB port connection. Additionally, when the emitter comprises an IR emitter, the emitter preferably is a multiple angled emitter, which helps insure that transmissions are received despite potential line of sight obstacles.

As will be appreciated, the appropriate response by the processor to an electronic signal will be dependent upon the media package, i.e., the media content being presented and the RUI being utilized. To illustrate this “dependency” point, take for example the base structure 150 of FIG. 6 and base structure 170 of FIG. 7. Either may accommodate any number of different overlays having similar or varying input arrangements such as, for example, the overlay 140 of FIG. 6 and the overlay 160 of FIG. 7. In this regard, base structure 150 is interchangeable with base structure 160, i.e., each base structure 150,160 may receive overlays 140 and 160. Moreover, the media content associated with overlay 140 may provide for workplace training of employees including, for example, sixteen training lessons to which the sixteen inputs of the overlay 140 correspond. In contrast, the media content associated with overlay 160 may comprise a five act play to which the five inputs of the overlay 160 correspond. In order for the processor of the base structure to take the appropriate response upon actuation of a user input of one of the overlays, the processor must be instructed how to respond as a function of the particular overlay to which it is attached. A signal received from one or more particular switches when a user input 142 of overlay 140 is actuated most likely should not result in the same response when a signal is received from the same switches when a user input 172 of overlay 160 is actuated. A signal that is received from a switch of the controller when overlay 140 is attached may result in the eighth training lesson being shown, whereas a signal that is received from the same switch of the controller when overlay 160 is attached may result in viewing of the third act of the play.

In order that the processor of the controller is properly instructed how to react when a signal is received, each RUI contains machine executable instructions stored in a machine readable medium, such as software stored in memory of the RUI. In preferred embodiments, the software comprises a script that is interpreted by the processor by running a program that is a script engine or script interpreter (hereinafter referred to as “Interpreter”). Furthermore, the script stored in the memory of the RUI preferably is at least partially compiled. The script essentially comprises control or navigational rules by which the Interpreter determines an appropriate response to receipt of a signal upon actuation of a user input. By providing script that is specific to media content associated with a particular overlay, overlays are able to couple to, and function with, similar or identical controllers; the scripts of the overlays provide the specific control or navigational rules appropriate to the media content to which the overlays correspond; in essence, the script provides the logic by which the Interpreter operates.

The script is read by the Interpreter through electrical contacts between the RUI and the controller. Again, with reference to FIGS. 8 and 11, script in overlay 141 resides in script element 145 and script in overlay 180 resides in script element 184. Electrical contacts 147 in RUI 141 and electrical contacts 186 in RUI 180 abut, respectively, electrical contacts 156 in controller 150 and electrical contacts 196 in controller 190 and respectively connection the processors in controllers 150,190 in communication with script elements 145,184. Furthermore, the script is read when the overlay is connected to the controller, or alternatively, on a case by case basis as a signal is received by the processor. The script storage element can include, for example, a magnetic strip, a removable memory cartridge, a memory disk, a read only memory (ROM) device, an erasable programmable read only memory (EPROM) device, any read only or read write memory device, an EEPROM or FLASH ROM device, an 12C standard device on a serial chip, or any magnetic or optical media memory storage device.

It will be appreciated that the script of a particular overlay, while dependent upon the media content, is not dependent upon, and thus is independent of, the particular host system, e.g., the particular DVD player that is used for presentation of the media content. Instead, the controller is dependent upon the particular host system in that the controller includes the particular communication protocol of the host system so that appropriate commands controlling the media presentation may be communicated to the host system. Moreover, the controller preferably includes a library of communication protocols or codes for different host systems, whereby the same controller can be used with different host system similar to the multiple use capability of “universal” remotes with various electronic devices of different manufacturers. The controller also preferably includes upgrade capabilities, whereby the library can be updated over time with additional communication protocols to ensure compatibility with future host systems and components thereof. Each protocol enables the Interpreter to communicate commands to the host system via the emitter for control of the media presentation. By making the RUI independent of the host system but dependent upon the media content, making the controller independent of the media package but dependent upon the host system, and by making RUIs removably attachable to different controllers, the present invention enjoys great flexibility and utility. Indeed, a single controller can serve a wide variety of overlays, and a single controller can be utilized with a wide variety of host systems.

With additional regard to the library of communication protocols of the controller, the Interpreter may access and read command codes of a particular host system as part of an initialization process when the overlay is coupled to the controller, or the Interpreter may read command codes periodically or upon actuation of a user input. Upon receipt of a signal, the Interpreter first refers to the script for the appropriate response and, then, refers to the particular protocol and command or commands of the host system, as reflected in the protocol for that host system, in order to achieve the appropriate response as identified with reference to the script. The Interpreter then causes the appropriate command or commands to be transmitted to the host system by the emitter. For example, an appropriate response to a signal that is received by the Interpreter may be, pursuant to the current script, to access a particular title and chapter, begin play, and then pause playback until an another signal is received as a result of a subsequent user actuation of a RUI input. To accomplish this response, the Interpreter determines the appropriate commands to communicate to the host system.

With additional regard to the Interpreter, the script language preferably comprises a complete media programming language written in modular fashion that includes features of conditional branches; states maintained; and variable data created, read, and updated. The Interpreter also preferably is backwards compatible for interpreting script written for older versions of the Interpreter, thereby allowing the software language to evolve without requiring hardware upgrades in the field. The script language preferably contains high level verbs that allow users to easily control interactive media, and contains all of the normal programming constructs, such as conditional statements, loops, macros, parameters, variable data, data storage, etc.

Each script preferably is developed utilizing an application programming interface (API) which can be a simple scripting language based upon standard XML protocols. The script language also preferably utilizes standards based and widely accepted XML syntax to provide the mechanism for scriptable media interactivity. Robust conditional logic and an event driven model enable considerable flexibility in the adaptability of instructions, making complex forms of interactivity possible.

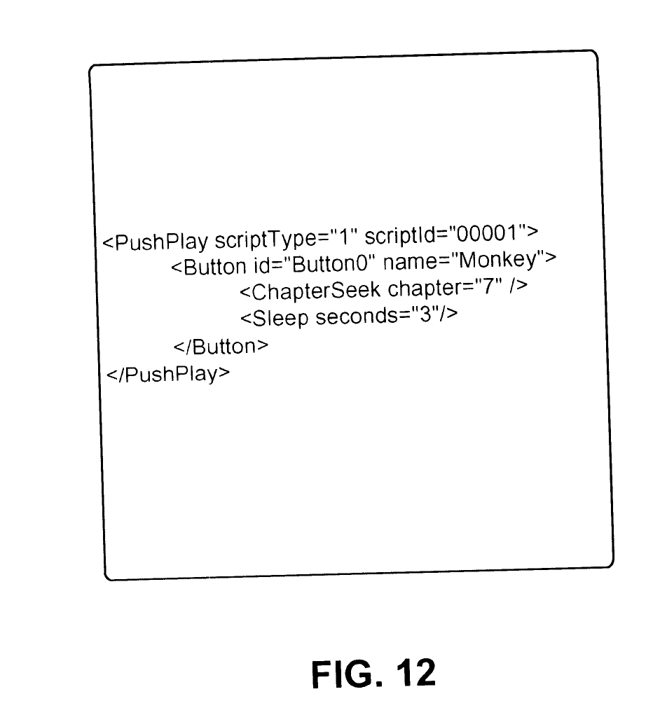

An exemplary script for an input comprising a button is shown in FIG. 12. In accordance with this simple example, when the Monkey Button is pressed, the presentation of the media content of Chapter 7 begins, which relates to monkeys.

With regard to further detail of the script structure, the syntax is XML elements and attributes. Commands (verbs) are XML elements. Parameters are XML attributes. Using this syntax, the script language is easily created or changed. Commands can be upgraded by modifying the parameters (attributes). New commands can be added, or dropped.

For example, if a command to issue the “Play” command to a DVD is desired, then the command that is utilized is <Play/>. If later the behavior of this command is to be changed, then parameters (attributes) could be added. Thus, the inclusion of a parameter “seconds” could be added. This parameter, if present, would issue the Play command for “n” seconds and then Pause, and the command would look like <Play seconds=“10”/>. Furthermore, such changes take place without modification of a compiler since they adhere to the XML syntax.

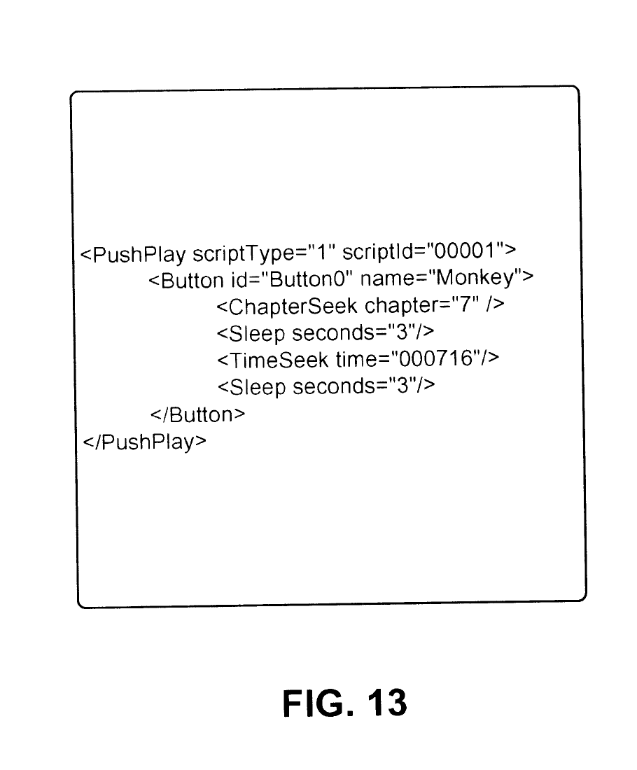

Another aspect of XML that is utilized in the script language is the concept of “child elements,” which provide many advantages. The primary use is to group commands to be executed when a particular user input (such as a button) is actuated. For example, a group of commands are issued when the “Monkey” button is pressed in accordance with the script of FIG. 13. This concept also is used for macros.

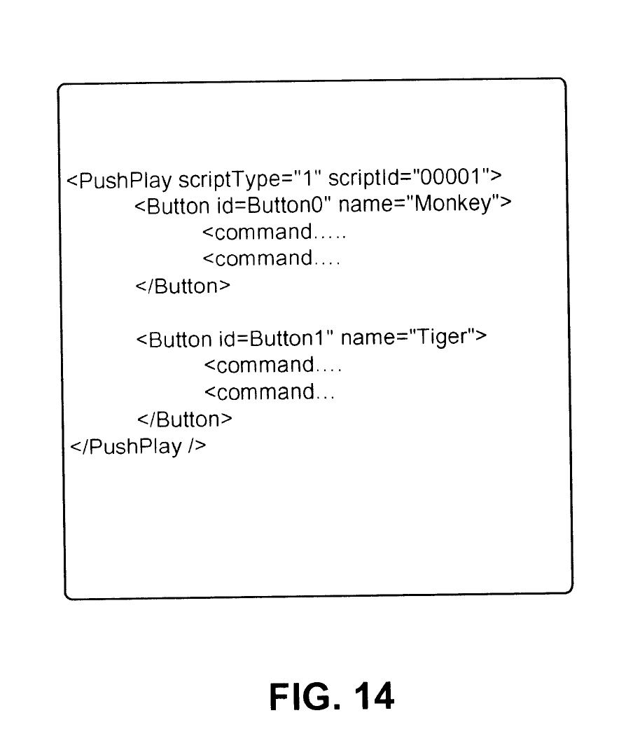

As will be apparent from the foregoing, a script in accordance with preferred embodiments of the present invention includes is a collection of media device independent commands for controlling media presentation, as illustrated in FIG. 14.

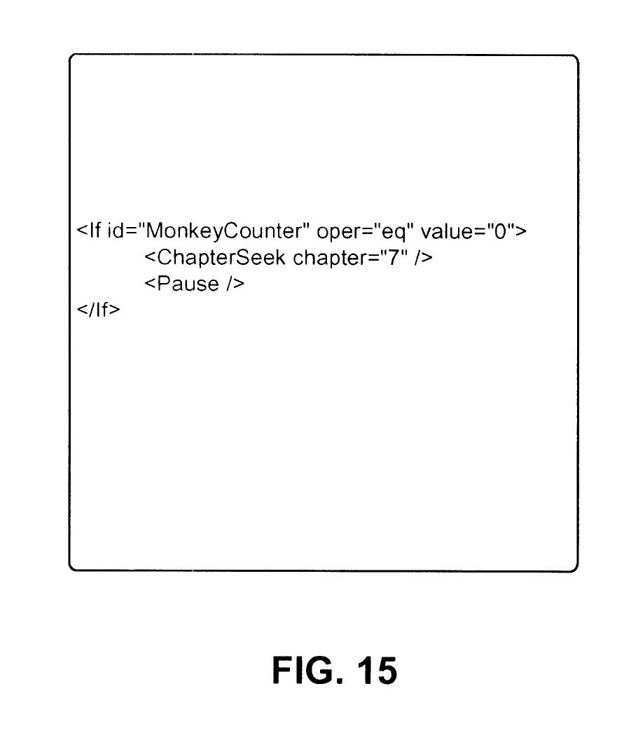

An example of a conditional statement in a script is shown in FIG. 15. Therein, all child elements (commands) are executed if the condition is true.

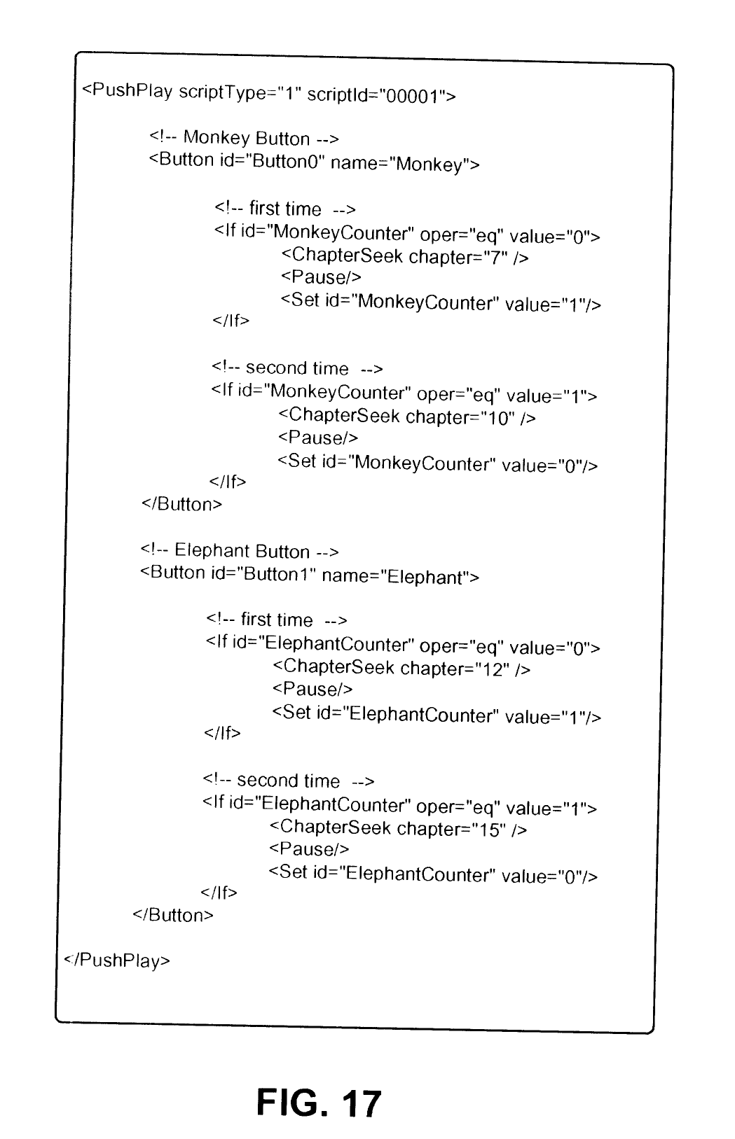

The exemplary script of FIG. 17 demonstrates a RUI having animal shaped user inputs comprising buttons. There are two buttons provided for, which include a Monkey button and an Elephant button. When the Monkey button is pressed, it displays the content in Chapter 7 of the DVD. When the button is pressed again it display the content in Chapter 10. When it is pressed again, it reverts back to Chapter 7. When the Elephant button is pressed, it first displays Chapter 12, and when it is pressed again, it then Chapter 15. This exemplary code demonstrates the robustness of the present invention in providing an appropriate response to actuation of a user input based on prior history of the user session during the presentation.

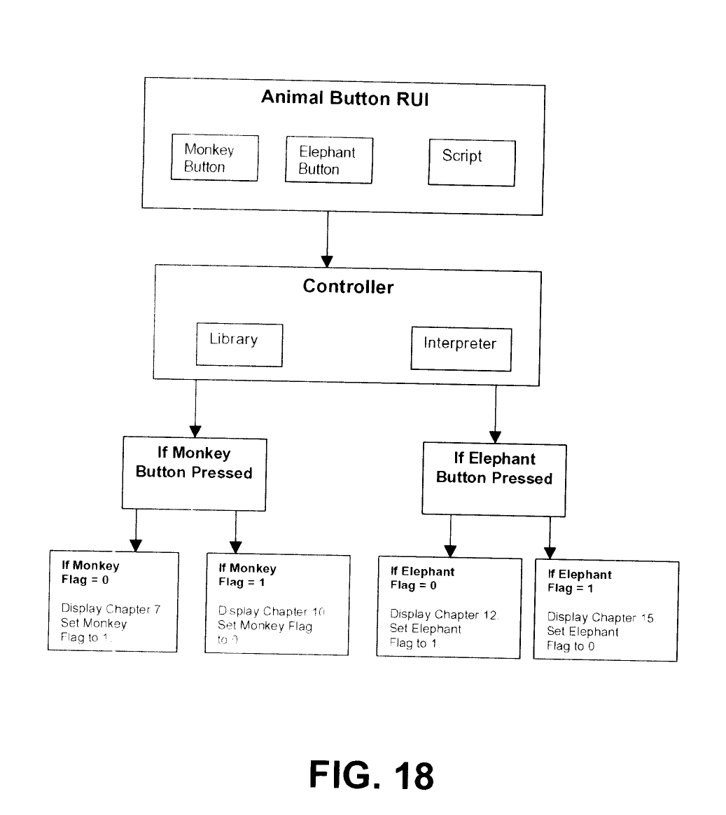

With reference to FIG. 18, the RUI represented therein contains, inter alia, a monkey shaped button and an elephant shaped button and the script element contains the script of FIG. 17. This particular RUI, for example, is associated with an educational video DVD about animals. Additionally, the controller includes the Interpreter and the library by which appropriate signals are able to be sent for controlling display of the media content on the DVD. The media device displaying the media content, for example, is a Sony DVD player.

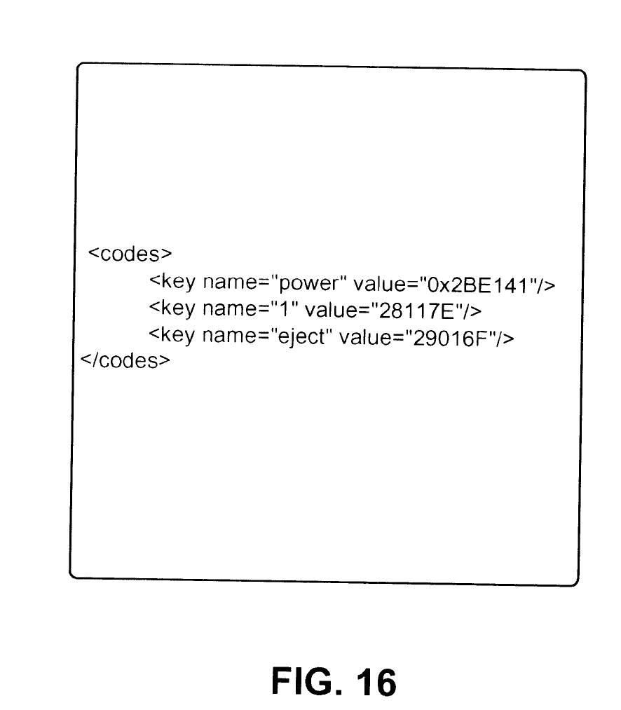

With reference to FIG. 16, machine-executable instructions of the library that are specific to the Sony DVD player are illustrated. These instructions are stored within the library of the controller and enable the controller to communicate, in an appropriate protocol of the Sony DVD player (e.g., via infrared transmission), the device-specific code for the command that is to be performed by the Sony DVD player. Examples of the “Power” command and “Eject” command are shown. Data associated with commands also can be communicated utilizing the library instructions (a command and associated data each generally being referred to herein as a command). An illustrated example of this in FIG. 16 is the instruction for communicating numeral “1” to the Sony DVD player.

In accordance with FIG. 18, when the monkey button is pressed, the Interpreter searches the Script to find the command to execute for this Button. Upon finding the appropriate command in the Script, the Interpreter checks the monkey flag in order to determine which Chapter to display. If the switch is 0, the Interpreter determines that Chapter 7 is to be displayed and, additionally, then sets the flag to 1. If, on the other hand, the flag is already 1, then the Interpreter determines that Chapter 10 is to be displayed and, additionally, sets the flag to 0. A similar method is utilized with respect to alternative actuation of the elephant button.

As demonstrated in FIG. 18, the effect of pressing the same button may be dynamic. The first time the button is pressed one chapter is displayed. On the second press, a different chapter is displayed. Also note that in the script of FIG. 17, no reference is found reflecting that the media device is a Sony DVD player; the script is independent of the media device. Specific codes for executing the commands in the script on the Sony DVD player are found in the library of the controller.

Scripts can be created with any available and suitable text editor. Additionally, scripts can be compiled into a machine independent format suitable for placing in script storage. Compiling a script can greatly reduce its size and allow its maintenance in machine independent format. A “drag and drop” visual editor can aid programming in the overlay software language and enable a producer with little programming skills to create interactivity instructions for a specific overlay. An integrated DVD player can allow editing, playback and testing from a single workstation. More technical users can be provided the option of editing using a more traditional development interface.

A programmer or developer adds commands to a “Table of Commands” in the Interpreter. The developer then provides the address of a software routine that will be called when the script so indicates by reference to the a command of the Table of Commands.

For example, when the “Sleep” command is Interpreted, the referenced program code performs the following,

a) Fetch the parameter “seconds”

b) Fetch the parameter “milliseconds”

c) Delay program execution for the appropriate amount of time as specified by the parameters.

If it were desired that the command be changed to have parameters for minutes and seconds instead of seconds and milliseconds, then it would be extremely easy to change the program code to support the different parameters. Moreover, no changes in a compiler or the Interpreter would be required. Thus, for a command to be removed, it only need be deleted from the Command Table and the code thereof removed that would otherwise be called in execution of the command. Conversely, to add a command, an entry in the Command Table on need be made with appropriate reference to the code for executing the command.

In accordance with preferred embodiments of the present invention, the script language preferably includes the following commands that relate to DVD players: MENU (stops title playback and displays the top or root menu for the current title of the DVD); TITLE (stops title playback and displays the title menu); RESUME (returns to playback mode from menu mode at the same title position as when the menu was invoked); BACK (returns the display from a submenu to its parent menu); PLAY (causes the DVD to start playing, or resumes play of a paused item); STOP (stops the playing of the DVD); PAUSE (pauses the playing of the chapter); NEXTCHAPTER (seeks and plays the next chapter; will loop); PREVCHAPTER (seeks and plays the previous chapter. Will loop); TITLESEEK (seeks and plays the first chapter in the title; title number is 1 to 99); CHPATERSEEK (seeks and plays the chapter in the current title; chapter number is 1 to 999); TIMESEEK (seeks to a specific time on the DVD; parameters include hour, minute, and second); FASTFORWARD (starts fast forwarding); FASTREVERSE (starts fast reversing); PUSHBUTTON (simulates a button press on a remote control device); and PUSHNUMBERS (simulates pressing the number buttons).

Basic commands that are found in all scripts regardless of the actual implementation of the present invention preferably include: PUSHPLAY (defines a new script; parameters include script type and id); BUTTON (defines commands that will be executed when signal for button is received); TRICKPLAY (defines a macro, whish is a collection of commands that will be executed multiple times; parameters can be passed that modify macro behavior); IF (Conditional command; will execute block of commands if condition is true); SET (sets value of a variable data item); @(FETCH) (returns value of a variable); INCREMENT (increments a variable with a range; when maximum limit is reached, will restart a minimum value); APPEND (appends a string value to a variable); BUTTONSON (enables PushPlay to react to button presses); BUTTONSOFF (disables PushPlay from reacting to button presses); SLEEP (sleeps for time period; awakens upon RUI input actuation); and SLEEPHARD (sleeps for time period; does not wakeup upon RUI input actuation).

Commands and parameters of a preferred embodiment implemented in computer software can be found in the file titled “PushPlayScriptingAPI.txt”, which is submitted herewith and is incorporated by reference herein. An exemplary script facilitating understanding of the present invention also can be found therein.

In a feature of the present invention, the Interpreter also monitors and records historical data regarding session use of a RUI. This collected data then may be utilized to modify future sessions or provide feedback to users. Such data may include the number of times a particular user input is actuated, the performance level of a user in interacting with an interactive media presentation, or the number of “right” answers that are provided by a user in response to certain media content, such as an interactive educational video. Memory in the controller and or the overlay may be utilized in storing such monitored data. Instructions for monitoring and recording the data, if any, preferably are included in the script.

In another feature of the present invention, the controller is a multi mode device and the interpreter maintains the state of the controller, whereby different responses may be provided as a function of the current state of the controller upon receipt of the same signal. For example, when the mode switch is set to position “1,” actuation of a specific user input may initiate the playing of chapter 10; however, when the mode switch is set to position “2,” actuation of the same user input may initiate the playing of the next chapter, or the playing of chapter 36, for example.

In view of the foregoing detailed description of preferred embodiments of the present invention, it readily will be understood by those persons skilled in the art that the present invention is susceptible of broad utility and application. While various aspects have been described in certain contexts, the aspects may be useful in other contexts as well. Many embodiments and adaptations of the present invention other than preferred embodiments described herein, as well as many variations, modifications, and equivalent arrangements, will be apparent from or reasonably suggested by the present invention and the foregoing description thereof, without departing from the substance or scope of the present invention.

Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions.

Accordingly, while the present invention has been described herein in detail in relation to preferred embodiments, it is to be understood that this detailed description is only illustrative and exemplary of the present invention and is made merely for purposes of providing a full and enabling disclosure of the invention. The foregoing disclosure is not intended, nor is to be construed to limit, the present invention or otherwise to exclude any such other embodiments, adaptations, variations, modifications and equivalent arrangements, the present invention being limited only by claims and the equivalents thereof.

For example, with regard to the preferred embodiment 100 of FIG. 1, the apparatus for controlling the media presentation is disclosed as being a child's activity table. Alternatively the apparatus can be constructed as a laptop unit to be placed on or over the lap of a seated user and can be constructed as a tray like unit for coupling with, for example, a child's chair having rails for receiving a tray.

In addition thereto, the overlay 132 of FIG. 4, for example, has been illustrated with rectangular keys. However, any shape of the keys may be used in accordance with the present invention and, in fact, the keys may be shaped in a manner that indicates the media content presented by user actuation of the keys. For instance, the keys of the overlay 132 of FIG. 4 may be shaped as alphabetic letters, with the shape of the keys comprising in this instance the aforementioned indicia of the user inputs. Indeed, the materials, shapes, and sizes of overlays are completely variable. An overlay can comprise a touch screen or a sheet of cardboard with imprinted buttons. User inputs may be spring loaded buttons that are, for example, plastic or rubberized. Exemplary user inputs include mechanical actuators that couple to electrical switches of a controller. Other examples include user inputs that are electrical switches that couple to conductive contacts of a controller.

Each RUI is specific to the medium content of a particular medium unit, with user input concepts that relate to its purpose and content, and look-and-feel branding based on the brand and/or content of the DVD. A RUI can have any size, shape, and form of user inputs that makes sense for its content and educational purpose. For example, the RUI and/or controller could resemble a book, wherein the turning of the pages of the book triggers a media event related to the content of the current page(s) of the book being viewed. The RUI also could take the form of a mini-piano, wherein certain notes or chords trigger particular video and/or audio presentations. More complex interactivity formats, like the “question-and-answer” format, could be used to teach and test specific notes and chords in learning to play the musical instrument. The RUI could further include a dance mat, wherein certain step combinations would trigger particular video and/or audio presentations. A RUI also could comprise a character or doll, wherein pressing of certain parts of the body would trigger media events for teaching about the body parts, etc. The RUI and/or the controller also could include a voice recognition component, wherein voice commands to trigger media events would be enabled.

Additionally, within the scope of the inventive system, there are various alternatives to storing scripts in a script element of a RUI for access by the Interpreter. Such alternatives include dynamically reading and accessing the script by the Interpreter, either wirelessly (IR, IRDA, radio) or wired (rs232, Ethernet, USB, etc.). This is especially convenient when the script has been compiled, making it easily portable to many different environments. Of course, the script that is accessed by the Interpreter would still need to be dependent upon the RUI that is used with the controller.

It will also be appreciated by those having ordinary skill in the art that the present invention encompasses not only presentation of media content, but control of other media events utilizing a controller and removable RUI. Thus, for instance, a command to record media content can be communicated to a host system in accordance with the present invention, with the RUI being associated with the media content to be recorded.

Finally, while the present invention has been described with regard to preferred embodiments directed to children toys and/or child education, the present invention is equally useful in a wide range of applications ranging from educational tools and product demonstrations to healthcare applications.

1. An apparatus for controlling a media event, comprising,
(a) a controller capable of communicating with a media device, said controller including,
(i) a processor for performing machine executable instructions for communicating device specific commands to the media device, and
(ii) a machine readable medium having the machine executable instructions for communicating device specific commands to the media device; and
(b) an overlay removably attached to said controller, said overlay including,
(i) a plurality of user inputs, and
(ii) a machine readable medium having machine executable instructions representing device independent commands for controlling media events;
(c) wherein, upon actuation of a said user input, said processor performs one or more of said instructions of said overlay representing device independent commands for controlling media events and, based thereon, performs one or more of the machine executable instructions for communicating device specific commands to the media device, resulting in said controller communicating one or more device specific commands to the media device, and, thereby controlling a media event.

2. The apparatus of claim 1, wherein said machine executable instructions of said overlay are specific to media content that is presented utilizing the media device.

3. The apparatus of claim 1, wherein said user inputs comprises buttons.

4. The apparatus of claim 1, wherein each of said user inputs comprises a button having indicia thereon representative of media content that is presented upon actuation of said button by a user.

5. The apparatus of claim 4, wherein said at least one user input comprises a designated area of said overlay.

6. The apparatus of claim 1, wherein said overlay comprises a switch matrix that provides an electronic signal upon actuation of a said user input.

7. The apparatus of claim 1, wherein said controller comprises a switch matrix that provides an electronic signal upon actuation of a said user input of said overlay.

8. The apparatus of claim 1, wherein the media event comprises media presentation.

9. The apparatus of claim 1, wherein the media event comprises capturing, recording, transferring, and/or moving of video and/or audio content.

10. The apparatus of claim 1, wherein said controller is capable of communicating device specific commands with each of a plurality of different media devices, and wherein said machine executable instructions of said overlay, which represent device independent commands for controlling media events, are independent of the different media devices.

11. The apparatus of claim 1, wherein each user input is disposed for direct contact by a user for actuation thereof.
